(19) United States
(12) Patent Application Publication
(10) Pub. No.: US 2011/0106861 A1
(43) Pub. Date: May 5, 2011

(54) Interface Techniques Providing Contiguous Storage For Files

(75) Inventor: Olli Luukkainen, Salo (FI)

(73) Assignee: Nokia Corporation

(21) Appl. No.: 12/612,178

(22) Filed: Nov. 4, 2009

(51) Int. Cl. G06F 12/00

(52) U.S. Cl. 707/821; 711/E12.001

(57) ABSTRACT

Methods, apparatus, and computer program products are disclosed. A method includes receiving information indicating at least a number of files and file size of each file, wherein each of the files is to be received and stored on a storage medium. The method includes, for each of the files, selecting whether the file is to be stored in contiguous or non-contiguous memory units in free memory units on the storage medium and determining corresponding contiguous or non-contiguous free memory units to use to store the file. The method also includes, in response to receiving one of the files, storing the received file in the corresponding previously determined contiguous or non-contiguous free memory units.

### TECHNICAL FIELD

This invention relates generally to file storage and, more specifically, relates to providing contiguous storage for files.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3G third generation

BT bluetooth

eMMC embedded multimedia card

exFAT extensible or extended FAT

FAT file allocation table

HDD hard disk drive

IrDA infrared data association

LBA logical block addressing

PC personal computer

PDA personal digital assistant

SD secure digital

UI user interface

USB universal serial bus

Mobile devices, such as mobile phones, digital still cameras, digital video cameras, media players, mobile phones, personal digital assistants (PDAs), and the like, maintain data on storage media. Storage media could be internal or external. Quite often, the file system on storage media (such as removable storage media supporting the universal serial bus mass storage device class) needs to be compatible with other devices such as personal computers. File allocation table (FAT) file systems, such as from MICROSOFT (a trademark of Microsoft Corporation), have had a dominate position in the market and many organizations take this into account when creating standards for memory. For example, the SD Association (SDA) mandates FAT file systems to be used with secure digital (SD) memory cards.

Microsoft has developed an “extensible” file system that will be used also with SD cards having sizes greater than about 32 gigabytes. This file system is called “exFAT” (for extensible or extended FAT). The exFAT file system might be used in an internal manner, so that the mobile device only (and not a USB mass storage or removable media) controls the file system structure. Further, the exFAT file system might be used even for file/object based storage media. File/object based storage media provides file/object access instead of sector/logical block addressing (LBA)-based access, and consequently the format of the file system is basically meaningless for a device reading or writing in file/object access. Regardless, the underlying file system still needs to read and write the files/objects from memory.

Storage media using these various file systems, and especially older FAT file systems, are very common Because of this, end users typically store a considerable amount of entertainment-type of files in these media, such as videos, music, and pictures. These files are also transferred between devices, using such wired or wireless networks as universal serial bus (USB) networks, Bluetooth (BT) networks, infrared data association (IrDA) networks, wide-area local access networks (WLANs), and third generation (3G) radio frequency networks. The typical use case is that multiple files are transferred in one session. There are different techniques to allow selection of files in the user interfaces (UIs) for mobile devices. For instance, in Nokia phones, a user can mark or unmark many files before launching a copy/move/delete operation, and similar interfaces are in PCs and other devices.

These types of use cases gain particular importance with the new extensible/extended file systems such as exFat. Illustratively, one version of an exFAT file system is described in U.S. Patent Publication no. 2009/0164539, which states the following in paragraph [0004]: “In the confines of the extensible file system format a method for creating and reading a file in a contiguous format is provided. During the creation and/or modification of a file on the storage media, the file system format checks the free space bitmap to determine if there are areas of free space on the media that would permit the storage of the file in a contiguous manner. By storing the file in a contiguous manner the file may later be read without resorting to the file allocation table, because the file itself would not be fragmented on the storage media.” With regard to extensible/extended file systems such as the system described in U.S. Patent Publication no. 2009/0164539 and use cases described previously, the following comments are made:

1. Contiguous storing of files is/has been important also with other file systems, but an extensible file system especially receives benefit from files stored contiguously.

2. Some types of files are accessed more randomly than are other types. For example, randomly accessed files may involve a large number of seek movements, and in this case contiguous storing of these files can provide efficient seek movements (e.g., a simple calculation is enough, and there is no need to process metadata). In a fragmented FAT/exFAT file system, a seek might require many metadata sector processing steps, whereas with a contiguously stored file, few or no processing steps need be taken.

3. Contiguous storage (i.e., writing contiguous sectors/blocks) is important also for the mass memories like embedded multimedia cards (eMMCs), SD cards etc. These storage media are better (e.g., faster) in contiguous writing than random writing.

A problem in utilizing contiguous file systems occurs when many or different types of files are stored in sequence (as in the use cases above) to a fragmented file system. Traditionally, a file system on a slave device receives files one by one and there is no information about other incoming files. So if multiple files are stored, the file system does not necessarily store the files in an optimal way in terms of contiguous file formats. What are needed are techniques to improve storage of files for files for those file systems that support contiguous file storage.

### BRIEF SUMMARY

In an aspect, a method is disclosed that receives information indicating at least a number of files and file size of each file, wherein each of the files is to be received and stored on a storage medium. The method includes, for each of the files, selecting whether the file is to be stored in contiguous or non-contiguous memory units in free memory units on the storage medium and determining corresponding contiguous or non-contiguous free memory units to use to store the file. The method also includes, in response to receiving one of the files, storing the received file in the corresponding previously determined contiguous or non-contiguous free memory units.

In another aspect, an apparatus is disclosed that includes at least one processor and at least one memory including computer program code, where the at least one memory and the computer program code are configured to, with the at least one processor, cause the apparatus to perform at least the following: receive information indicating at least a number of files and file size of each file, wherein each of the files is to be received and stored on a storage medium. The apparatus is further configured to, for each of the files, select whether the file is to be stored in contiguous or non-contiguous memory units in free memory units on the storage medium and determining corresponding contiguous or non-contiguous free memory units to use to store the file. The apparatus is further configured to, in response to receiving one of the files, store the received file in the corresponding previously determined contiguous or non-contiguous free memory units.

In another aspect, a computer program product is disclosed that includes a computer-readable medium bearing computer program code embodied therein for use with a computer. The computer program code includes code for receiving information indicating at least a number of files and file size of each file, wherein each of the files is to be received and stored on a storage medium. The computer program code also includes code for, for each of the files, selecting whether the file is to be stored in contiguous or non-contiguous memory units in free memory units on the storage medium and determining corresponding contiguous or non-contiguous free memory units to use to store the file. The computer program code also includes code for, in response to receiving one of the files, storing the received file in the corresponding previously determined contiguous or non-contiguous free memory units.

In another aspect, an apparatus is disclosed that includes means for receiving information indicating at least a number of files and file size of each file, wherein each of the files is to be received and stored on a storage medium. The apparatus also includes means, for each of the files, for selecting whether the file is to be stored in contiguous or non-contiguous memory units in free memory units on the storage medium and determining corresponding contiguous or non-contiguous free memory units to use to store the file. The apparatus further includes means, in response to receiving one of the files, for storing the received file in the corresponding previously determined contiguous or non-contiguous free memory units.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 is an example of one system suitable for use with embodiments of the invention;

FIG. 2 is a signaling diagram of exemplary signaling between devices in FIG. 1 for providing contiguous storage for files;

FIG. 3 is an example of one system suitable for use with embodiments of the invention;

FIG. 4 is a signaling diagram of exemplary signaling between devices in FIG. 3 for providing contiguous storage for files;

FIG. 5 is an example of one system suitable for use with embodiments of the invention;

FIG. 6 is a signaling diagram of exemplary signaling between devices in FIG. 5 for providing contiguous storage for files;

FIG. 7, including FIGS. 7A and 7B, illustrates examples of a file stored in contiguous memory units (FIG. 7A) and stored in non-contiguous memory units (FIG. 7B);

FIG. 8, including FIGS. 8A and 8B, illustrates an example of a memory with free memory units (FIG. 8A) and an example of how file type attributes are used to select which files are stored in contiguous memory units and which are not;

FIG. 9 is a flow diagram of an exemplary method for providing contiguous storage for files;

FIG. 10 is a flow diagram of an exemplary method for determining where a file to be received will be stored and whether the file will be stored using contiguous or non-contiguous memory units;

FIG. 11 is a flow diagram of another exemplary method for determining where a file to be received will be stored and whether the file will be stored using contiguous or non-contiguous memory units; and

FIG. 12 is an example of information communicated in one of the steps of FIG. 11.

### DETAILED DESCRIPTION OF THE DRAWINGS

An exemplary embodiment of the invention introduces an interface (e.g., a method, apparatus, computer program product, etc.) that is used by a host device to provide information about files to be stored before any/few of files have been stored to a storage media. This interface could also operate in the reverse manner, i.e., a receiving device could query for information about files to be received when the host device indicates there are files to be transferred.

In an exemplary embodiment, the interface provides more efficient allocation of contiguous space for files that are to be and subsequently are received. For example, based on file attributes, such as file size or type, the interface can determine which files to store contiguously (i.e., in contiguous memory units) and which to store non-contiguously (i.e., in non-contiguous memory units). As an example, files with smaller sizes could be given higher priority for being assigned contiguous storage, and larger files could be given lower priority, which should mean that more smaller files will be stored contiguously. The opposite could also be true, that larger files are given higher priority. Yet another example is that certain files such as video files could be given higher priority such that videos file will be (or will attempt to be) stored in contiguous memory units, and other files with lower priority will be (or will attempt to be) stored in non-contiguous memory units. Exemplary interfaces can be implemented in pure software implementations (that run on hardware), all hardware implementations, or some combination thereof (e.g., software that is connected to hardware registers providing location to information about the files to be stored).

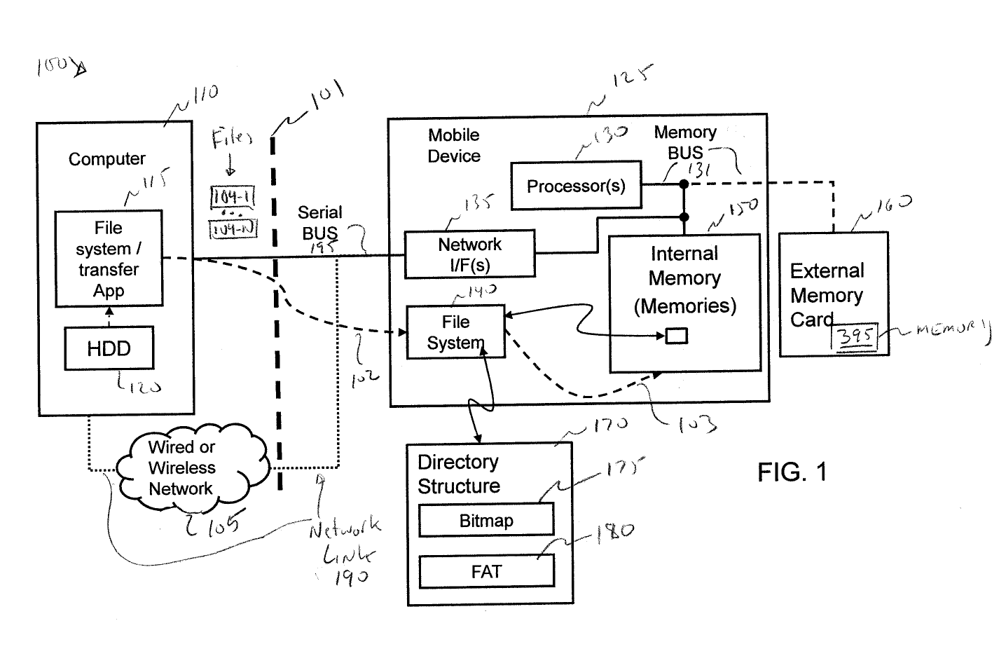

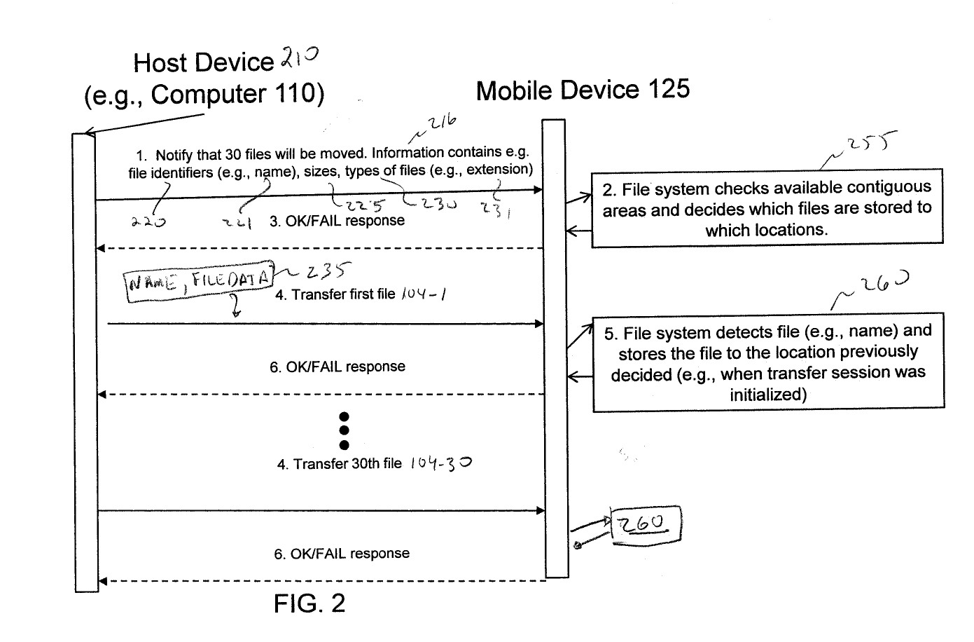

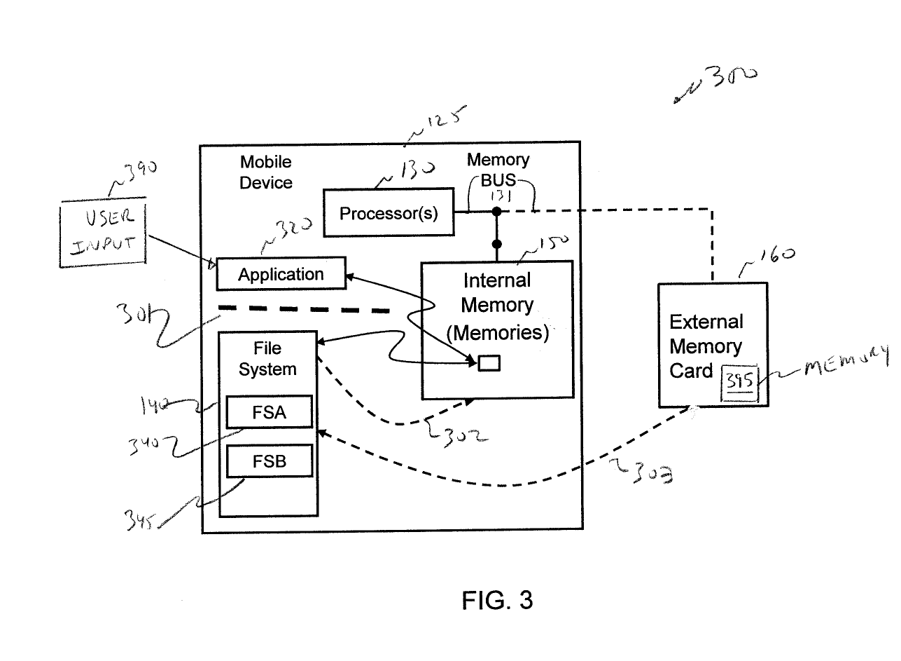

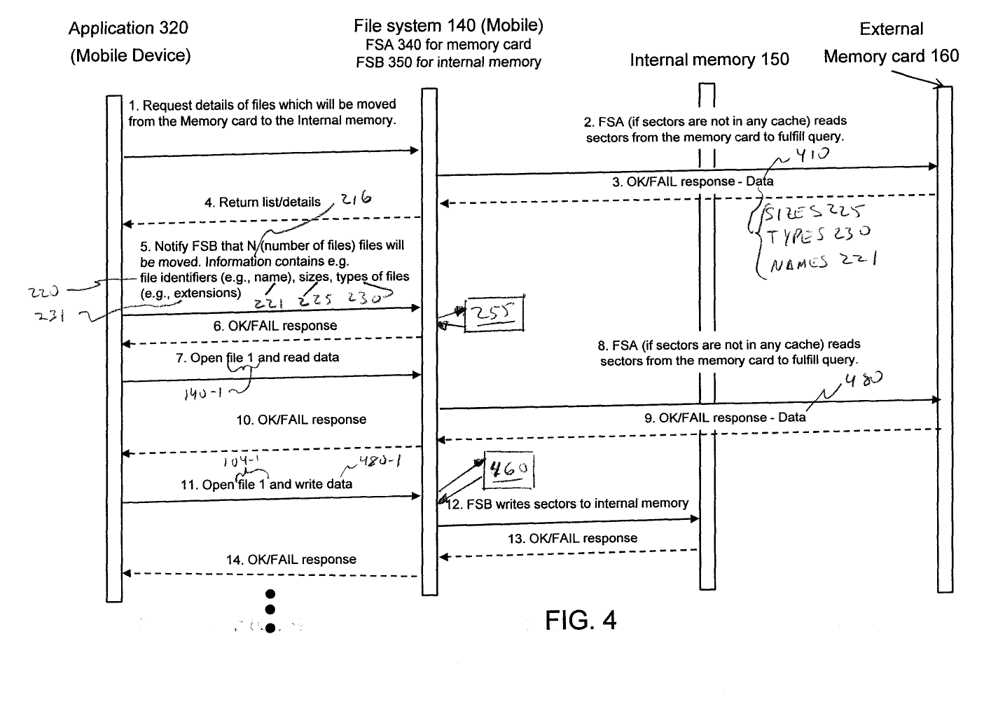

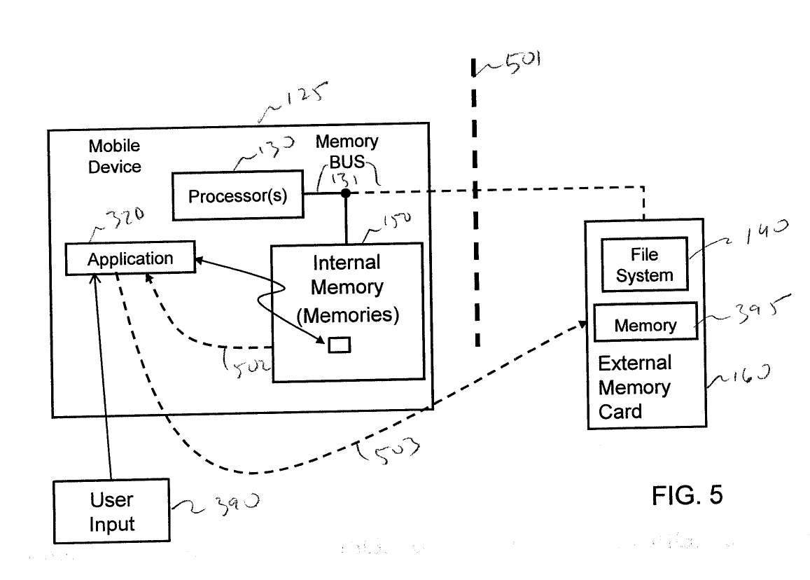

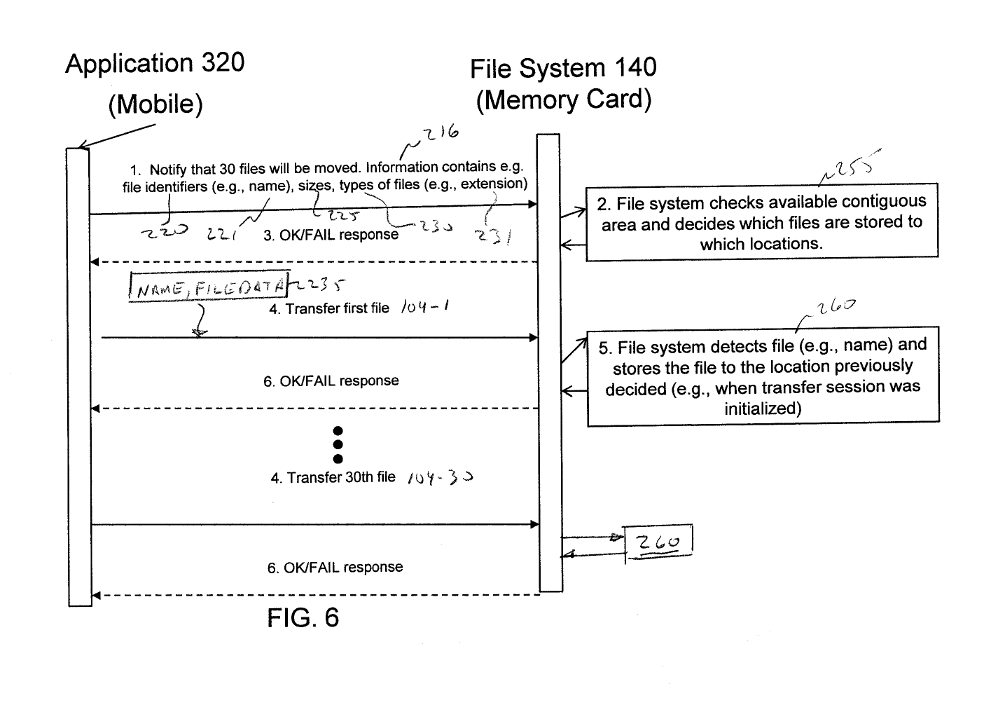

In an exemplary embodiment, an interface occurs between a host device such as a computer and a mobile device (see FIGS. 1 and 2). In another exemplary embodiment, the invention is implemented inside a mobile device, and an advantage of this is that such implementation can be implemented without any external support. See FIGS. 3 and 4. In another exemplary embodiment, an interface occurs between a mobile device (or, e.g., a computer) and movable storage media such as an external memory card, and the movable storage media contains a file system implementing much of the interface. See FIGS. 5 and 6. Still other combinations are possible, as one skilled in the art may realize. The exemplary interfaces introduced herein help to achieve the full benefit of contiguous file information and use.

Referring now to FIG. 1, an example of one system 100 suitable for use with embodiments of the invention is shown. System 100 includes a computer 110, containing a file system/transfer application 115 and a hard disk drive (HDD) 120. The computer 110 is coupled to a mobile device 125 through in one example a serial bus 195, and in another example a wired or wireless network 105 and wired or wireless network links 190. The mobile device 125 includes one or more processors 130, a memory bus 131, one or more internal memories 150, and network interface(s) 135. In an example, the internal memories 150 contain a file system 140 and a directory structure 170, which contains a bitmap 175 and a FAT 180. In an exemplary embodiment, the file system 140 and file system/transfer application 115 implement parts of an interface. Line 101 illustrates graphically where this interface occurs, although the actual interface itself is embodied in file system/transfer application 115 and file system 140 in this example. Illustratively, the file system 140 may be a software implementation placed into internal memories 150 and executed by the processors 130. The file system 140 can access the directory structure 170 or the directory structure 170 can form part of the file system 140. In the example of FIG. 1, it is assumed the file system 140 contains the directory structure 170. In this example, the file system 140 includes both executable portions (shown in FIG. 1 because the file system 140 is separate from the directory structure 170) and the directory structure 170 into which files are placed.

It should be noted that the computer 110 will typically have one or more processors and one or more memories, and the file system/transfer application 115 will be loaded from the one or more memories and into the one or more processors for execution.

The bitmap 175 is a map that maintains a record of the allocation states of all memory units (e.g., sectors or clusters) on the memories 150. The bitmap 175 may be, in an exemplary embodiment, that described in U.S. Patent Publication no. 2009/0164539. The term memory unit will be used herein to indicate some accessible amount of memory. This amount depends on the file system 140 being used. For instance, FAT file systems use “clusters” to refer to a chunk of sectors. The terms “block” and “sector” quite often are used interchangeably. Sector/block is usually the minimum readable/writable unit on the memory (such as a HDD, NAND flash, SD memory card, eMMC memory, etc.), and a cluster is the minimum allocation unit in certain file systems (e.g., FAT32, exFAT). Although a given file system 140 could write/read a sector (e.g., 512 bytes), the file system 140 might be organized so that each file allocates, as an example, N*8*cluster (e.g., N*8*512 bytes). In other words, if a file contains one byte, it would be allocated to one cluster, which contains eight sectors, even though the file can be stored within a single sector. Therefore, the term “memory unit” can include a sector or cluster (or other allocation unit), depending on how the file system 140 operates.

Furthermore, a “memory unit” may also be any element of memory, such as pages or cache lines of memory. The invention is not limited to FAT, exFAT, and similar file systems. Additionally, continuous memory units can be physically adjacent or logically adjacent. For instance, a memory might have column addresses and contiguous memory units on this memory could be logically adjacent because the column addresses are incremented between the contiguous memory units, but physically the columns could be spaced apart (e.g., separated by other columns). In terms of file systems, the invention is applicable to many different file systems. For example, the file systems ext2, ext3 and ext4 have “block bitmap” structures to manage allocation status of the blocks (which have blocks of bytes similar to a cluster in FAT file systems). With these file systems, writing or reading contiguous files is not that important from the file system performance point of view, but underlying hardware performance issues are similar to those experienced with exFAT. For instance, eMMC/SD cards can provide better read (and write) performance if contiguous sectors are read (or written). Therefore heavily accessed/seeked files should be stored contiguous manner and less heavily accessed/seeked files could be stored fragmented manner The file systems ext2, ext3 and ext4 are merely additional examples of file systems suitable for use with the invention.

The computer 110 (e.g., as a host device) is going in this example to transfer files 104-1 through 104-N to the mobile device 125, and this transfer is illustrated by paths 102 and 103. In this case, the files 104 are acted upon (path 102) by the file system 140 to be stored (path 103) in the internal memories 150. Internal memories 150 and the memory 395 in external memory card 160 are storage media. The term “storage media” refers to any type of media, include memory card, eMMC, NAND flash, NOR flash and the like. For example, one could say that a mobile device has storage media for storing files. The actual storage media could vary, such one mobile device having only NOR flash memory (a medium that allows very “low level” of abstraction, similar to pure bit-manipulated flash memory), and another mobile device could have eMMC (which offers quite a “high level” of abstraction and basically inside of eMMC, several different flash technologies could be used). Referring also to FIG. 2, this figure is a signaling diagram of exemplary signaling between devices in FIG. 1 for providing contiguous storage for files. The host device 210 (e.g., computer 110) notifies (Step 1) the mobile device 125 that N files (30 files in this example) are to be transferred (e.g., moved) from the host device 210 to the mobile device 125. More specifically, the file system/transfer application 115 of computer 110 can be considered as causing the host device 210 to perform the actions shown in FIG. 2, and the file system 140 of the mobile device 125 can be considered as causing the mobile device 125 to perform the actions shown in FIG. 2. The Step 1 includes information 216 such as file identifiers 220 (e.g., indications of the file names 221), indications of sizes 225 of the files to be transferred, and indications of types 230 (e.g., through indications of the extensions 231) of the files 104.

The file system 140 then checks (Step 2) available contiguous memory units and decides which files 104 are stored to which locations. Step 2 is referred to in FIG. 2 and subsequent figures as Step 255. The decisions are described in more detail below. The mobile device 125 sends (Step 3) an OK/FAIL response to the host device 210. Steps 1-3 can be considered an initialization of a transfer session. It should be noted that the OK/FAIL response in this and other figures is one exemplary implementation. However, a response is not necessary. Further, should responses be used, the response could contain more information than an OK/FAIL acknowledgement.

The host device 210 transfers (Step 4) the first file 104-1. The file system 140 detects the file 104-1 using, e.g. an indication of a file name 221. Such indication of the file name 221 can be included in message 235, containing indication of the file name and the file data. It should be noted that multiple steps might be necessary to transfer a file 104. In Step 5, the file system 140 stores the file 104-1 to the previously decided locations of contiguous (or non-contiguous) memory units in internal memories 150. Step 5 is referred to as Step 260 in FIG. 2 and subsequent figures. Steps 4, 5, and 6 are repeated for each of the 30 files, until file 104-30 has been transferred and stored.

In general, the various embodiments of the mobile device 125 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions. The mobile device 125 can also use wired access technologies, such as wired networking or universal serial bus technologies.

The computer readable memories 150, 395 may be of any type of storage media suitable to the local technical environment and may be implemented using any suitable data storage technology, such as semiconductor based memory devices, flash memory, magnetic memory devices and systems, optical memory devices and systems, fixed memory and removable memory. The processors 130 may be of any type suitable to the local technical environment, and may include one or more of general purpose computers, special purpose computers, microprocessors, digital signal processors (DSPs) and processors based on a multicore processor architecture, as non-limiting examples.

Turning now to FIGS. 3 and 4, FIG. 3 is an example of one system 300 suitable for use with embodiments of the invention, and FIG. 4 is a signaling diagram of exemplary signaling between devices in FIG. 3 for providing contiguous storage for files. In this example, system 300 includes a mobile device 125 having an application 320, which communicates with the file system 140 to cause the file system 140 to move files from the memory 395 of the external memory card 160 (using path 303) to the internal memories 150 (e.g., using path 302). The application 320 is a move application which accepts user input 390, which selects which files will be moved from the memory 395 of the external memory card 160 to the internal memories 150. The file system 140 includes file system A (FSA) for the external memory card 160 and file system B (FSB) for the internal memories 150, as in this example the two file systems are different. Line 301 illustrates graphically where the interface occurs, which is between the application 320 and the file system 140 in this example, although the actual interface itself is embodied in application 320 and file system 140.

In Step 1, the application 320 requests from the file system 140 the details (such as size 225 or types 230) of the files 104. The file system 140, as FSA 340, reads (if the sections are not already in cache) memory units (sectors in this example) from the external memory card 160 to fulfill the request (e.g., a query). The FSA 340 responds (Step 3) with an OK/Fail response in Step 3 and data 410 of the details. The data 410 includes indications of sizes, 225, types 230, and file names 221 of the files 104.

The application 320 notifies the file system 140, as FSB 350, that N files will be moved using a message (Step 5). The information 216 includes in this example file identifiers 220 (e.g., indications of the file names 221), indications of sizes 225 of the files to be transferred, and indications of types 230 (e.g., through indications of the extensions 231) of the files 104. Step 255 is performed between Steps 6 and 7, and in Step 255, the file system 140 checks available contiguous memory units (e.g., areas) and decides which files 104 are stored to which locations. In Step 7, the application 320 requests the file system 140 (as FSA 340) to open “file 1” (e.g., file 104-1) and to read data. The FSA 340 in Step 8 reads (if sectors in this example are already not in a cache) from the external memory card 160 to fulfill the request (e.g., a query). The FSA fulfills the request because the external memory card 160 transfers data 480-1 from file 104-1 in its memory 395 to the FSA 340. It should be noted that only one response, Step 9, is shown, but there could be multiple responses.

The application 320 then requests (Step 11) the file system 140 (as FSB 350) to perform a write of the data 480-1 to the internal memories 150. The FSB 350 performs Step 460 at this point, which is to determine into which previously decided locations the file 104-1 will be stored. The FSB 350 writes the data 480-1 to previously determined memory units (sectors in this example) in the internal memories 150 in Step 12. Step 13 is an OK/FAIL response message from internal memories 150 and Step 14 is an OK/FAIL response message from file system 140 to the application 320. Steps 7 through 14 would be repeated for the rest of the files 104 and data 480 of the N files, until all files have been transferred from the external memory card 160 to the internal memory 150.

Referring now to FIGS. 5 and 6, FIG. 5 is an example of one system suitable for use with embodiments of the invention, and FIG. 6 is a signaling diagram of exemplary signaling between devices in FIG. 5 for providing contiguous storage for files. This example has mobile device 125 (and more specifically, application 320) interfacing with the external memory card 160 (and more specifically, file system 140). Line 501 illustrates graphically where this interface occurs, although the actual interface itself is embodied in application 320 and file system 140. The application 320, under direction of user input 390, is going to transfer (e.g., move) files from internal memories 150 (as illustrated by path 502) to the external memory card 160 (as illustrated by path 503). In this example, the file system 140 is implemented as a hardware/firmware package embedded in the external memory card 160.

The application 320 notifies (Step 1) the file system 140 (on external memory card 160) that N files (30 files in this example) are to be transferred (e.g., moved) from the mobile device 125 to the external memory card 160. The message in Step 1 includes information 216 such as file identifiers 220 (e.g., indications of the file names 221), indications of sizes 225 of the files to be transferred, and indications of types 230 (e.g., through indications of the extensions 231) of the files 104.

The file system 140 then checks (Step 2) available contiguous memory units (e.g., areas) and decides which files 104 are stored to which locations. Step 2 is also step 255 of FIG. 2. The file system 140 (and memory card 160) sends (Step 3) an OK/FAIL response to the host device 210. Steps 1-3 can be considered an initialization of a transfer session.

The application 320 (and mobile device 125) transfers (Step 4) the first file 104-1. The file system 140 detects the file 104-1 using, e.g. an indication of a file name 221. Such indication of the file name 221 can be included in message 235, containing indication of the file name and the file data. It should be noted that multiple steps might be necessary to transfer a file 104. In Step 5, the file system 140 stores the file 104-1 to the previously decided locations of contiguous (or non-contiguous) memory units in external memory card 160. Step 5 is also Step 260 in FIG. 2. Steps 4, 5, and 6 are repeated for each of the 30 files, until file 104-30 has been transferred and stored.

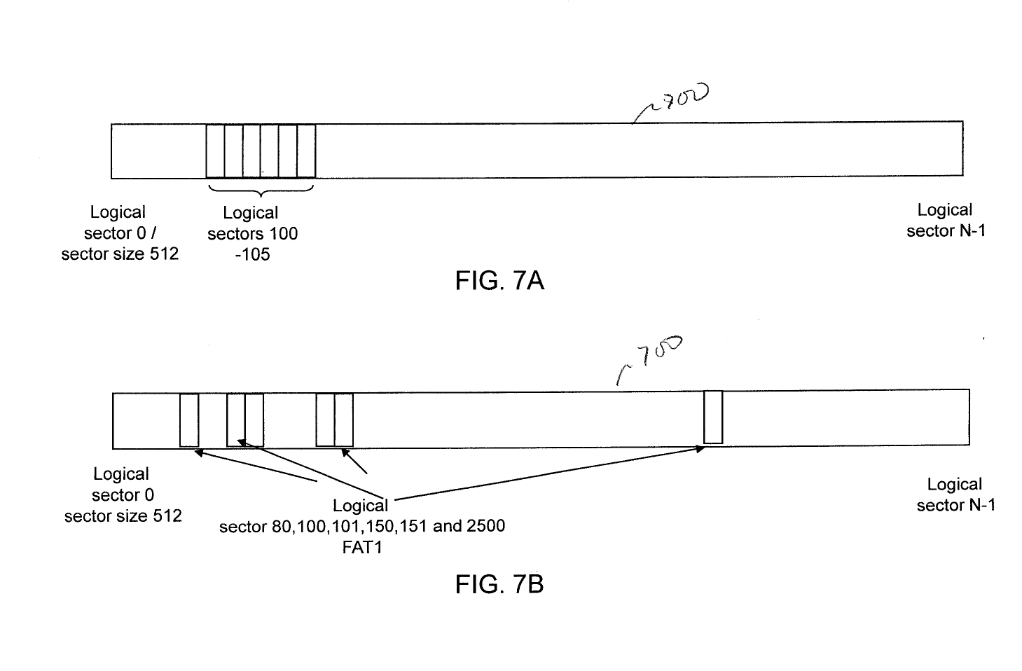

Turning to FIG. 7, including FIGS. 7A and 7B, this figure illustrates examples of a file stored in contiguous memory units (FIG. 7A) and stored in non-contiguous memory units (FIG. 7B). It can be seen that storing files contiguously as in FIG. 7A will result in fewer seeks to the memory 700 as compared to the non-contiguous storage of the same file in non-contiguous sectors (FIG. 7B).

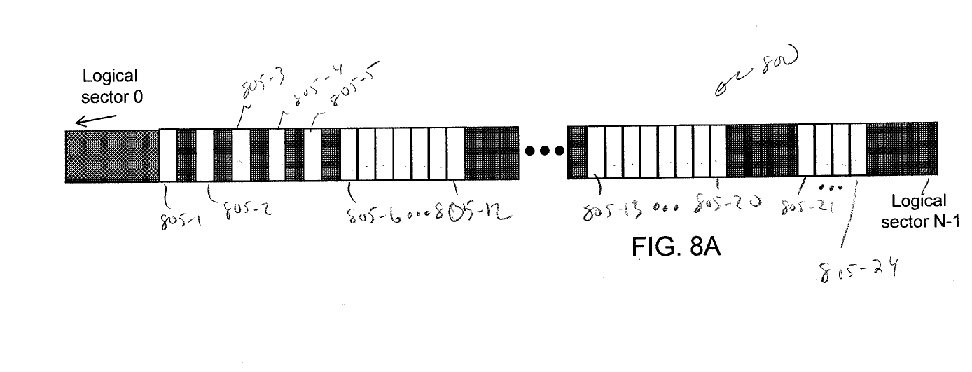

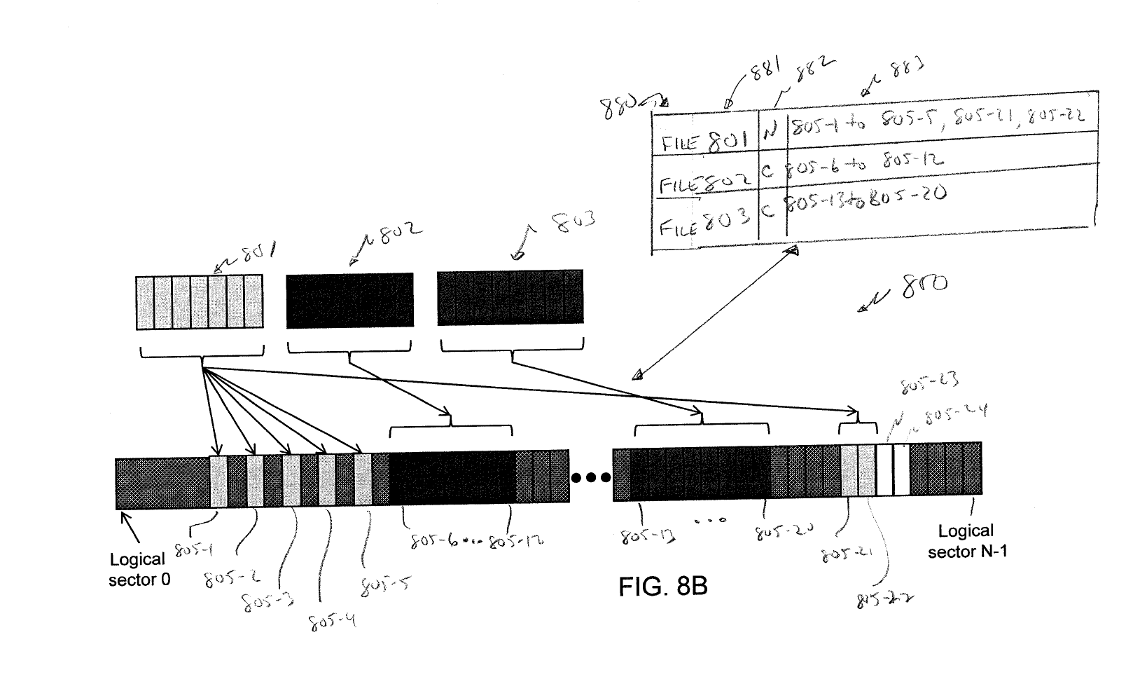

Referring now to FIG. 8, including FIGS. 8A and 8B, this figure illustrates an example of a memory 800 with free memory units (FIG. 8A) and an example of how file type attributes are used to select which files are stored in contiguous memory units and which are not. The free memory units 805-1 through 805-24 are available to be filled in FIG. 8A. As shown above in relation to the examples of FIGS. 2, 4, and 6, an initialization includes determining where files 801, 802, and 803 will be stored in the free memory units 805 prior to the files being transferred through the interface. In an exemplary embodiment, the file attribute of file type (e.g., file type 230, determined using, e.g., an extension 231) is used to determine whether a file 801, 802, and 803 is to be stored as a contiguous file or not. In the example of FIG. 8B, the files 802 and 803 are video, which have the potential for a larger number of seeks into memory, relative to other file types such as images. In particular, the video file format might be such that metadata and payload might be located within the file so that ‘seeking’ is needed to get video during playback. Further, a user also may cause memory seeks for video such as by pausing, restarting fast forwarding, and rewinding. By contrast, image file 801 is given lower priority for contiguous storage because it is unlikely memory seeks will be made into the file 801. It should noted that this example uses video as being assigned a higher priority to contiguous memory units of free memory, but the invention is not limited to this and many other file types (such as files having security parameters, executable files, etc.) may be assigned higher (or lower) priorities for free memory units 805.

In this example, because the video files 802 and 803 are assigned higher priority to be allocated to free memory units 805, free memory units 805-6 through 805-12 are “reserved” for video file 802 and free memory units 805-13 through 805-20 are “reserved” for video file 803. Further, since there are no longer any contiguous free units of free memory units 805 to hold the image file 801, this file 801 will be stored in non-contiguous free memory units 805-1 through 805-5, 805-21, and 805-22. In response to the files 801, 802, 803 being received (e.g., in this order), a file system 140 stores the files 801, 802, 803 in the predetermined, “reserved” free memory units 805 of memory 800. It should also be noted that these files are received in this example with image file 801 being received first, video file 802 being received second, and video file 803 being received last.

A mapping table 880 is an example of how predetermined reservations might be made of the free memory units 805 to be assigned to the files 801, 802, and 803, and the mapping table 880 is accessed in response to these files being received. Mapping table 880 includes an indication 881 (such as a file identifier 220, which could be a file name 221) of the file (in this case, the file names 221 of “File 801”, “File 802”, and “File 803”), an indication 882 of whether the file is to be stored in a non-contiguous manner (N) or whether the file is to be stored in a contiguous manner (C), and indications 883 of the reserved free memory units 805.

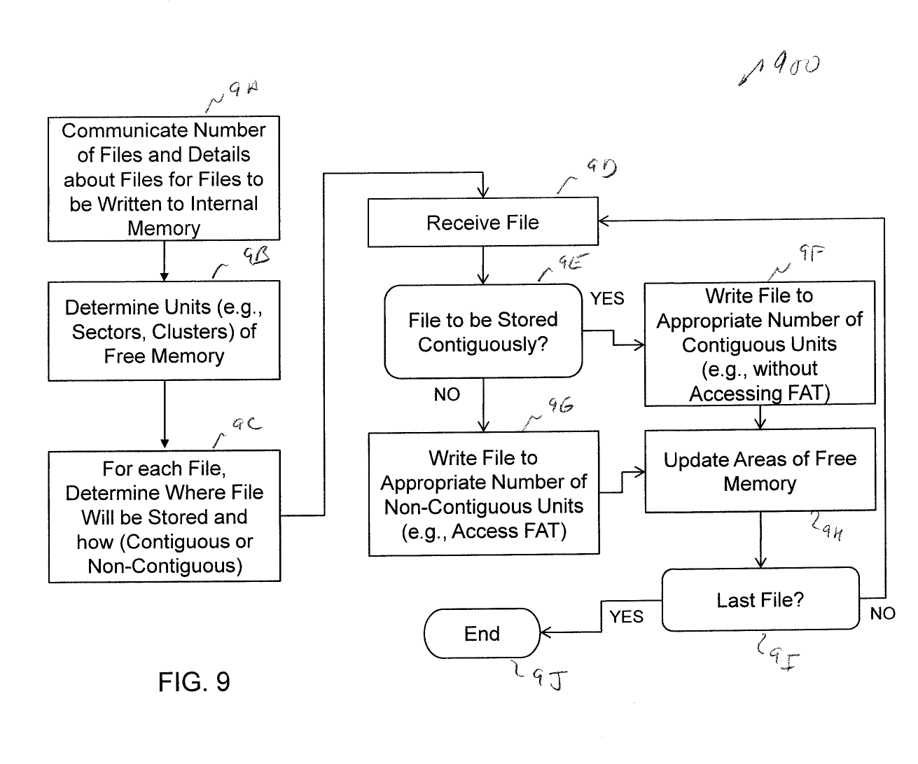

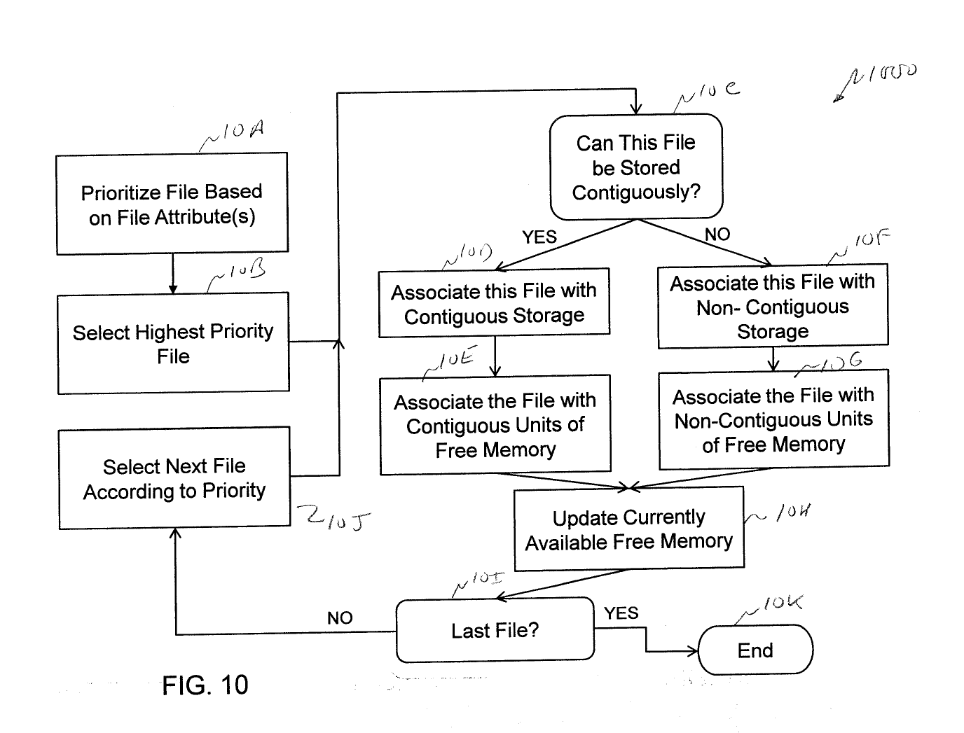

Priority may be assigned using file attributes such as types 230 of files, sizes 225 of files (e g , smallest files are given higher priority, or largest files are given higher priority), or through other attributes. It should be noted that the free memory units 805 may be reserved by taking these memory units 805 out of a mapping (e.g., using bitmap 175 of FIG. 1) of free memory units 805, such that these memory units 805 are considered to be in use, or these could be reserved only logically and not reserved actually until the file transfer and subsequent writing occurs. In FIGS. 9 and 10 below, it is assumed that the latter occurs, which is that the free memory units are only logically reserved and not actually reserved until the file transfer and subsequent writing occurs.

Turning now to FIG. 9 with appropriate reference to other figures, this is a flow diagram of an exemplary method 900 for providing contiguous storage for files. In block 9A, indications of a number (e.g., N) of files and details (such as size 225) about the files are communicated. For instance, a host device 210 transmits the information 216 to the mobile device 125 (see FIGS. 1 and 2), which receives the information 216. In block, 9B, the units of free memory are determined, e.g., by accessing the bitmap 175 (see FIG. 1). In Block 9C, for each file, a determination is made as to in which memory units the file will be stored and whether the file will be stored in contiguous or non-contiguous memory units. Block 9C is described in more detail in reference to FIG. 10.

In Block 9D, one of the N files is received, and a determination is made whether this file is to be stored contiguously or not (Block 9E). The actual determination was already made in Block 9C, so Block 9E looks up (using, e.g., the table 880 shown in FIG. 8) the previously determined decision as to whether the file will be stored contiguously. If the file is to be stored contiguously (Block 9E=YES), the file is written to the appropriate number of contiguous memory units (Block 9F) and in an embodiment, the FAT is not accessed. On the other hand, if the file is to be stored non-contiguously (Block 9E=NO), the file is written to the appropriate number of non-contiguous memory units (Block 9G), which in an exemplary embodiment requires access to and updating of the FAT.

Blocks 9F and 9G both converge to Block 9H, where free units of memory are updated, e.g., by accessing the bitmap 175 of FIG. 1 and marking the memory units written to in either of Blocks 9F or 9G as occupied. In block 9I, it is determined if this is the last of the N files. If not (Block 9I=NO), the method 900 continues in Block 9D; if so (Block 9I=YES), the method 900 concludes in Block 9J.

Turning to FIG. 10 with appropriate reference to other figures, this figure is a flow diagram of an exemplary method for determining where a file to be received will be stored and whether the file will be stored using contiguous or non-contiguous memory units. Method 1000 is a more detailed explanation of Block 9C of FIG. 9. Method 1000 begins in Block 10A when files to be subsequently received and written to memory are prioritized. The prioritization uses one or more file attributes, such as file sizes 225 or file types 230, or some combination thereof. As described in relation to FIG. 8, file types 230 such as video files may be assigned higher priority to contiguous memory unit storage than other file types, such as image files. Alternately, file attributes such as file size can be used to assign larger (or smaller) files higher priority than other smaller (or larger, respectively) files. The file size 225 may also be used in conjunction with the types 230, such that files having certain file types 230 are assigned higher priority, then within the files having the certain file types 230, file size is additionally used to assign priority. For instance, Video File A having a size 225 of 10 may be given a higher priority than Video File B having a size 225 of 5, and both of these may be given higher priority than Image File C, even though Image File C may have a higher size 225 than one or both of Video Files A and B.

In Block 10B, the file with the highest priority is selected, and Block C determines whether this file can be stored contiguously in free memory units (e.g., free memory units 805 of FIG. 8). If the file can be stored contiguously (Block 10C=YES), the file is associated with contiguous storage (Block 10D), and contiguous areas of free memory units are associated with the file (Block 10E). If the file cannot be stored contiguously (Block 10C=NO), the file is associated with non-contiguous storage (Block 10F), and non-contiguous areas of free memory units are associated with the file (Block 10G).

In Block 10H, an update is made to the currently available free memory units. For instance, in the table 880, when the File 802 has the contiguous areas of memory 805-6 through 805-12 associated with the File 802, these units of memory 805-6 through 805-12 are no longer part of the available free memory. In the example of FIG. 10, this update is to a “copy” of the available free memory (e.g., as no markings are made in the bitmap 175 to indicate this free memory is now in use until Block 9H of FIG. 9). However, alternative embodiments can update the bitmap 175 in Block 10H to indicate these areas of memory are no longer available.

In Block 10I, it is determined if the last file has been selected. If not, the method 1000 continues in Block 10J, when the file with the next highest priority is selected. If so, the method 1000 ends in Block 10K.

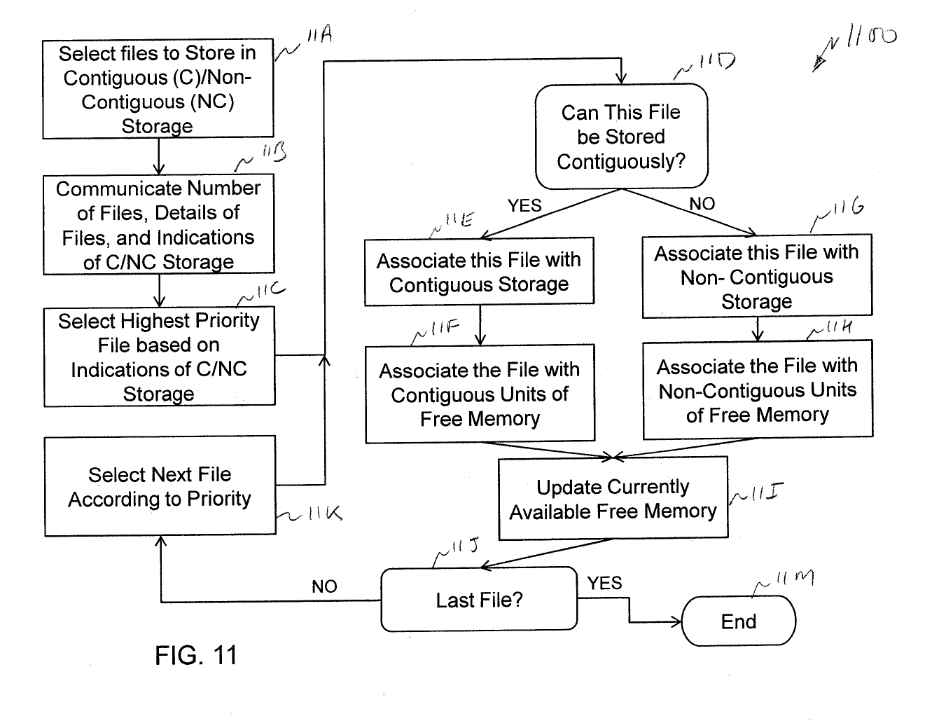

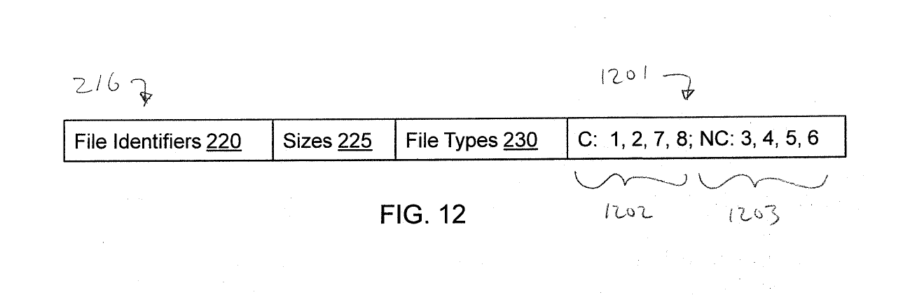

In the embodiments shown above, an entity such as file system 140 is the entity that selects whether a file is to be stored in a contiguous (using contiguous memory units) or fragmented (using non-contiguous memory units) manner. However, an entity such as the file system/transfer application 115 in FIG. 1 and the applications 320 of FIGS. 2 and 3 can also make this selection and then communicate indications of the selection to the file system 140. FIGS. 11 and 12 illustrate a version of this exemplary embodiment. Turning now to FIGS. 11 and 12, FIG. 11 is a flow diagram of another exemplary method for determining where a file to be received will be stored and whether the file will be stored using contiguous or non-contiguous memory units, and FIG. 12 is an example of information communicated in one of the steps of FIG. 11.

In method 1100 of FIG. 11, a transmitting entity (e.g., file system/transfer application 115 in FIG. 1 or the applications 320 of FIGS. 2 and 3) selects the files to store contiguously (Block 11A). This selection may be made, as described above, by using file types or file sizes or other criteria. In Block 11B, the host communicates a number of files, details of files, and indications of contiguous (C) or non-contiguous storage to a receiving entity (e.g., file system 140). FIG. 12 shows information 216 that is communicated from the transmitting entity to the receiving entity. In this example, the information 216 includes file identifiers 220, file sizes 225, file types 230, and indications 1201 of which files should be stored contiguously (contiguous file indications 1201) or non-contiguously (non-contiguous file indications 1203). In this case, files 1, 2, 7, and 8 are to be stored contiguously, while files 3, 4, 5, and 6 are to be stored non-contiguously. Note that these are preferences, as the receiving entity may not be able to store a particular file contiguously. In this example, there is no priority between the files to be stored contiguously, such that file 1 has the same priority as file 8. However, the order of the files in contiguous file indications 1202 could be, e.g., from highest priority (file 1) to lowest priority (file 8). Also, the contiguous file indications 1202 may be sent without the non-contiguous file indications 1203 (and vice versa), as the files to be stored non-contiguously (or contiguously) can be inferred.

The receiving entity performs blocks 11C through 11K. The receiving entity selects a highest priority file based on the indications 1201 of contiguous/non-contiguous storage. In the case of FIG. 12, where no priority is given for the continuous file indications 1202, the receiving entity could select one of the files 1, 2, 7, or 8 based on its order within the continuous file indications 1202 or based on this or other criteria (e.g., file sizes 225).

Blocks 11D, 11E, 11F, 11G, 11H, 11I, and 11J are the same as respective Blocks 10C, 10D, 10E, 10F, 10G, 10H, and 10I in FIG. 10 (that is, Block 11D is the same as Block 10C, etc.). In Block 11K, the file with the next highest priority is selected. This selection is based at least on indications 1201 of contiguous/non-contiguous storage. In Block 11M, the method 1100 ends.

Without in any way limiting the scope, interpretation, or application of the claims appearing below, a technical effect of one or more of the example embodiments disclosed herein is to provide more efficient storage of files in contiguous memory units. Another technical effect of one or more of the example embodiments disclosed herein is to provide priorities (relative to other files) to certain files for storage in contiguous memory units.

Embodiments of the present invention may be implemented in software, hardware, application logic or a combination of software, hardware and application logic. The software, application logic and/or hardware may reside on computer systems or mobile devices. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIGS. 1, 3, and 5. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
receiving information indicating at least a number of files and file size of each file, wherein each of the files is to be received and stored on a storage medium;
for each of the files, selecting whether the file is to be stored in contiguous or non-contiguous memory units in free memory units on the storage medium and determining corresponding contiguous or non-contiguous free memory units to use to store the file; and
in response to receiving one of the files, storing the received file in the corresponding previously determined contiguous or non-contiguous free memory units.

2. The method of claim 1, wherein selecting further comprises determining a priority for each of the files based at least in part on file attributes in the received information, the file attributes comprising the file size, the priority indicating a preference for storage of a file in the contiguous memory units, and using the priority when selecting whether the file is to be stored in contiguous or non-contiguous free memory units on the storage medium.

3. The method of claim 2, wherein selecting further comprises selecting a file to be stored in the contiguous memory units in the free memory units in response to priority for the file being higher than priorities of all of the other files in the number of files.

4. The method of claim 2, wherein the file attributes further comprise a file type for each of the files, and wherein the determined priority for a particular one of the files is based on the file type of that particular file.

5. The method of claim 2, wherein selecting further comprises determining the priority for each of the files based at least in part on one of a plurality of file attributes in the received information, or a single file attribute in the information.

6. The method of claim 1, wherein selecting and determining further comprises determining free memory units on the storage medium, creating a mapping between each of the files and corresponding contiguous or non-contiguous free memory units to use to store the file, and removing the corresponding contiguous or non-contiguous free memory units from the determined free memory units.

7. The method of claim 1, wherein storing further comprises storing the one file in the corresponding previously determined contiguous free memory units, where storing is completed without accessing a file allocation table, and where storing comprises accessing a bitmap containing indications of free memory units and updating the bitmap to indicate that the previously determined contiguous free memory units are no longer free.

8. The method of claim 1, wherein storing further comprises storing the one file in the corresponding previously determined non-contiguous free memory units, and the storing is completed by accessing and updating a file allocation table.

9. The method of claim 1, wherein the information further comprises indications of which of the files are to be stored in contiguous memory units, and wherein selecting further comprises selecting, using at least the indications, whether the file is to be stored in contiguous or non-contiguous memory units.

10. An apparatus, comprising:
at least one processor; and
at least one memory including computer program code,
the at least one memory and the computer program code configured to, with the at least one processor, cause the apparatus to perform at least the following:
receiving information indicating at least a number of files and file size of each file, wherein each of the files is to be received and stored on a storage medium;
for each of the files, selecting whether the file is to be stored in contiguous or non-contiguous memory units in free memory units on the storage medium and determining corresponding contiguous or non-contiguous free memory units to use to store the file; and
in response to receiving one of the files, storing the received file in the corresponding previously determined contiguous or non-contiguous free memory units.

11. The apparatus of claim 10, wherein selecting further comprises determining a priority for each of the files based at least in part on file attributes in the received information, the file attributes comprising the file size, the priority indicating a preference for storage of a file in the contiguous memory units, and using the priority when selecting whether the file is to be stored in contiguous or non-contiguous free memory units on the storage medium.

12. The apparatus of claim 11, wherein selecting further comprises selecting a file to be stored in the contiguous memory units in the free memory units in response to priority for the file being higher than priorities of all of the other files in the number of files.

13. The apparatus of claim 11, wherein the file attributes further comprise a file type for each of the files, and wherein the determined priority for a particular one of the files is based on the file type of that particular file.

14. The apparatus of claim 11, wherein selecting further comprises determining the priority for each of the files based at least in part on one of a plurality of file attributes in the received information, or a single file attribute in the information.

15. The apparatus of claim 10, wherein selecting and determining further comprises determining free memory units on the storage medium, creating a mapping between each of the files and corresponding contiguous or non-contiguous free memory units to use to store the file, and removing the corresponding contiguous or non-contiguous free memory units from the determined free memory units.

16. The apparatus of claim 10, wherein storing further comprises storing the one file in the corresponding previously determined contiguous free memory units, where storing is completed without accessing a file allocation table, and where storing comprises accessing a bitmap containing indications of free memory units and updating the bitmap to indicate that the previously determined contiguous free memory units are no longer free.

17. The apparatus of claim 10, wherein storing further comprises storing the one file in the corresponding previously determined non-contiguous free memory units, and the storing is completed by accessing and updating a file allocation table.

18. The apparatus of claim 10, wherein the information further comprises indications of which of the files are to be stored in contiguous memory units, and wherein the computer code is further configured to cause the apparatus, when selecting, to select, using at least the indications, whether the file is to be stored in contiguous or non-contiguous memory units.

19. A computer program product comprising a computer-readable medium bearing computer program code embodied therein for use with a computer, the computer program code comprising:
code for receiving information indicating at least a number of files and file size of each file, wherein each of the files is to be received and stored on a storage medium;
code for, for each of the files, selecting whether the file is to be stored in contiguous or non-contiguous memory units in free memory units on the storage medium and determining corresponding contiguous or non-contiguous free memory units to use to store the file; and
code for, in response to receiving one of the files, storing the received file in the corresponding previously determined contiguous or non-contiguous free memory units.

20. The computer program product of claim 19, wherein selecting further comprises determining a priority for each of the files based at least in part on file attributes in the received information, the file attributes comprising the file size, the priority indicating a preference for storage of a file in the contiguous memory units, and using the priority when selecting whether the file is to be stored in contiguous or non-contiguous free memory units on the storage medium.

21.-28. (canceled)
